(19) United States
(12) Patent Application Publication
(10) Pub. No.: US 2021/0271734 A1
(43) Pub. Date: Sep. 2, 2021

(54) PROCESSING DEVICE, METHOD, AND PROGRAM

(71) Applicant: NIPPON TELEGRAPH AND TELEPHONE CORPORATION, Tokyo (JP)

(72) Inventors: Ryota IMAI, Tokyo (JP); Tatsushi MATSUBAYASHI, Tokyo (JP); Hiroshi SAWADA, Tokyo (JP)

(73) Assignee: NIPPON TELEGRAPH AND TELEPHONE CORPORATION, Tokyo (JP)

(21) Appl. No.: 17/254,200

(22) PCT Filed: Jun. 14, 2019
(86) PCT No.: PCT/JP2019/023756

§ 371 Date: Dec. 18, 2020

(30) Foreign Application Priority Data
Jun. 21, 2018 (JP) 2018-118092

(51) Int. Cl. G06F 17/16; G06F 7/78

(52) U.S. Cl. CPC G06F 17/16; G06F 7/78

(57) ABSTRACT

It is possible to perform factorization at high speed while maintaining consistency. Based on each of the plurality of tensors, a graph is constructed in which a plurality of factor matrices obtained by decomposing the tensors are set as vertices, and the vertices of factor matrices obtained by decomposing a same tensor are connected by edges. Assigning a number to each vertex of the graph is assigning the number so that the same number is not assigned to the other vertex connected by an edge. An order of updating the factor matrices is determined in a manner that factor matrices assigned a same number are set as a set of factor matrices to be subjected to parallel processing. Updating the factor matrices, based on the plurality of tensors, in the order of updating is repeatedly updating the set of factor matrices to be subjected to parallel processing in parallel.

### TECHNICAL FIELD

The present invention relates to processing device, method and program, and more particularly to processing device, method, and program for performing factorization for extracting a pattern.

### BACKGROUND ART

As a technique for extracting a factor pattern from a plurality of pieces of attribute information, there are techniques called non-negative tensor factorization (NTF) and non-negative multiple tensor factorization (NMTF) (NPL 1). In the NTF/NMTF, first, each initial value of factor matrices corresponding to input tensors is determined using random numbers or the like. Next, processing of updating all factor matrices based on an update formula (factor matrix update processing) is repeatedly performed in order to improve values of each factor matrix. When one factor matrix is updated, it is necessary to refer to other related factor matrices, and accordingly, in the conventional technique, each factor matrix is updated sequentially.

Note that the attribute information represents an event by a combination of one or more attributes and a corresponding value. For example, the event that people have visited a store can be represented by three attributes (user ID, store ID, day of week) and the corresponding number of visits or stay time. The attribute information can be represented as a tensor when each attribute is regarded as a mode.

A tensor is synonymous with a multi-dimensional array in the following description. For example, a third-order tensor can be represented as a three-dimensional array. However, a non-negative tensor refers to a tensor in which value of every element of the tensor is 0 or more.

The mode refers to the axis of the tensor. For example, a matrix can be regarded as a second-order tensor, which has two modes, the row direction and the column direction.

The factor matrix is a matrix obtained by factorizing a non-negative tensor, and factor matrices are of the same number as modes.

### CITATION LIST

### Non Patent Literature

[NPL 1] Non-negative Multiple Tensor Factorization (K Takeuchi, R Tomioka, K Ishiguro, A Kimura, H Sawada, ICDM, 2013)

### SUMMARY OF THE INVENTION

### Technical Problem

In the conventional technique (NPL 1), each factor matrix is sequentially updated in the factor matrix update processing. In other words, a plurality of factor matrices is not updated at the same time. This is because updating one factor matrix requires referring to the values of other related factor matrices, so updating the plurality of factor matrices at the same time without taking such a relationship into consideration causes inconsistency in calculations.

If the reference relationship between factor matrices is trivial, some of the factor matrices can be updated at the same time while maintaining consistency. However, in NMTF, the relationship between factor matrices is complicated, which is not trivial. For example, in an NTF with one third-order tensor, there are three factor matrices, and each factor matrix refers to the two factor matrices other than itself, so it is trivial that there is no combination of factor matrices that can be updated at the same time. On the other hand, in NMTF, since there is a plurality of tensors in any order and there are also any number of shared factor matrices for any set of tensors, there is a possibility that there is a combination of factor matrices that can be updated at the same time but no specific combination is trivial.

For the above reasons, in the conventional technique, there is a problem that it is difficult for a processing execution device having a plurality of CPU cores or hardware specialized for parallel calculation to shorten the processing time by making efficient use of surplus calculation resources while updating one factor matrix.

The present invention has been made to solve the above problems, and an object of the present invention is to provide a processing device, a method, and a program capable of performing factorization at high speed while maintaining consistency.

### Means for Solving the Problem

In order to achieve the above object, a processing device according to a first aspect of the present invention is a processing device that decomposes each of a plurality of tensors into a plurality of factor matrices so that when each of the tensors represented by a multi-dimensional array in which axes are set as modes corresponding to attributes is decomposed into a plurality of factor matrices, at least one of the factor matrices obtained by decomposing the tensor is shared with a factor matrix obtained by decomposing another tensor. The processing device includes an update order determination unit that determines an order of updating the factor matrices in a manner that based on each of the tensors, the factor matrices obtained by decomposing the plurality of tensors are set as vertices, a graph is constructed in which vertices of factor matrices obtained by decomposing a same tensor are connected by edges, each vertex of the graph is assigned a number so that the vertex is not assigned the same number as the other vertex connected by the edge, and factor matrices assigned a same number are set as a set of factor matrices to be subjected to parallel processing; and a tensor decomposition unit that decomposes each of the tensors into the factor matrices in a manner that based on the tensors, the factor matrices are updated in the order of updating by repeatedly updating the set of factor matrices to be subjected to parallel processing in parallel.

Further, in the processing device according to the first aspect of the present invention, the update order determination unit may assign the number so that for each of subgraphs, in the graph, which is composed of vertices of a plurality of factor matrices obtained by decomposing a tensor and edges between the vertices of the factor matrices, the vertices of the subgraph are assigned different numbers, each being not the same number as the other vertex connected by the edge, in order starting from a predetermined number.

A processing method according to a second aspect of the present invention is a processing method for a processing device that decomposes each of a plurality of tensors into a plurality of factor matrices so that when each of the tensors represented by a multi-dimensional array in which axes are set as modes corresponding to attributes is decomposed into a plurality of factor matrices, at least one of the factor matrices obtained by decomposing the tensor is shared with a factor matrix obtained by decomposing another tensor. The processing method to be performed includes a step of determining, by an update order determination unit, an order of updating the factor matrices in a manner that based on each of the tensors, the factor matrices obtained by decomposing the plurality of tensors are set as vertices, a graph is constructed in which vertices of factor matrices obtained by decomposing a same tensor are connected by edges, each vertex of the graph is assigned a number so that the vertex is not assigned the same number as the other vertex connected by the edge, and factor matrices assigned a same number are set as a set of factor matrices to be subjected to parallel processing; and a step of decomposing, by a tensor decomposition unit, each of the tensors into the factor matrices in a manner that based on the tensors, the factor matrices are updated in the order of updating by repeatedly updating the set of factor matrices to be subjected to parallel processing in parallel.

A program according to a third aspect of the present invention is a program for causing a computer to function as the units of the processing device according to the first aspect of the present invention.

### Effects of the Invention

According to the processing device, method, and program of the present invention, an order of updating the factor matrices is determined in a manner that based on each of the tensors, the factor matrices obtained by decomposing the plurality of tensors are set as vertices, a graph is constructed in which vertices of factor matrices obtained by decomposing a same tensor are connected by edges, each vertex of the graph is assigned a number so that the vertex is not assigned the same number as the other vertex connected by the edge, and factor matrices assigned a same number are set as a set of factor matrices to be subjected to parallel processing; and each of the tensors is decomposed into the factor matrices in a manner that based on the tensors, the factor matrices are updated in the order of updating by repeatedly updating the set of factor matrices to be subjected to parallel processing in parallel. Accordingly, there is obtained an effect that it is possible to perform factorization at high speed while maintaining consistency.

### BRIEF DESCRIPTION OF DRAWINGS

FIG. 1 is a diagram illustrating an example of the relationship between a factor matrix and a tensor.

FIG. 2 illustrates an example of a diagram for explaining a k-partite graph.

FIG. 3 illustrates an example of a diagram for explaining a k-partite graph.

FIG. 4 illustrates an example of a diagram for explaining a k-partite graph.

FIG. 5 illustrates an example of a diagram for explaining a k-partite graph.

FIG. 6 illustrates an example of a diagram for explaining a k-partite graph.

FIG. 7 is a block diagram illustrating a configuration of a processing device according to an embodiment of the present invention.

FIG. 8 illustrates an example of tensors stored in an input data storage unit.

FIG. 9 is a block diagram illustrating a configuration of an update order determination unit.

FIG. 10 is a block diagram illustrating a configuration of a tensor decomposition unit.

FIG. 11 is a flowchart illustrating a processing routine in the processing device according to the embodiment of the present invention.

FIG. 12 is a flowchart illustrating details of processing of a factor matrix classification unit.

FIG. 13 is a diagram illustrating an example of assigning numbers to the vertices of a subgraph.

FIG. 14 is a flowchart illustrating details of processing of an update order output unit.

FIG. 15 is a diagram illustrating a relationship between vertices and an update order list.

FIG. 16 is a flowchart illustrating details of processing of a matrix update unit.

### DESCRIPTION OF EMBODIMENTS

Hereinafter, embodiments of the present invention will be described in detail with reference to the drawings.

<Outline of Processing Device According to Embodiment of Present Invention>

First, a basic definition of an embodiment of the present invention will be described.

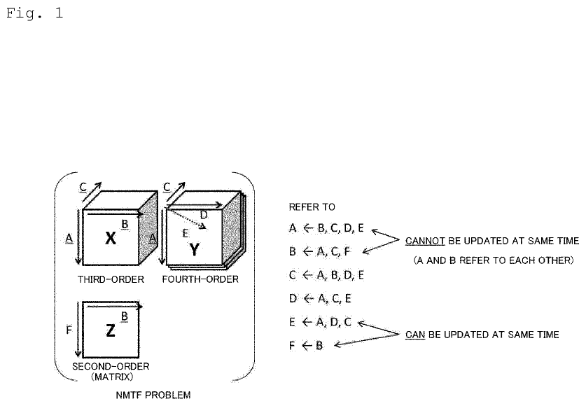

As illustrated in FIG. 1, since the relationship between a factor matrix and a tensor is complicated in the NMTF problem, there is a problem that the parallel update procedure that can maintain consistency in calculations is not obvious. In FIG. 1, since A and B as tensor modes refer to each other, they cannot be updated at the same time. The combinations that can be updated at the same time are (A, F), (B, D), (B, E), (C, F), (D, F), (E, F) and the other modes refer to each other.

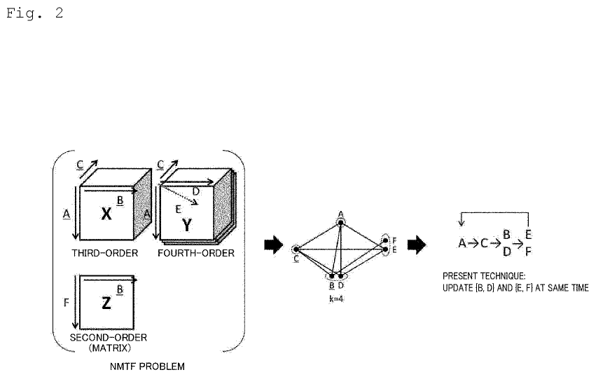

Therefore, in the embodiment of the present invention, as illustrated in FIG. 2, a k-partite graph is constructed and used in which relationships between tensors and factor matrices are graphed under a certain rule, for solving the problem. The k-partite graph is a graph in which a vertex set is divided into k subsets and the vertices in each subset have no edges. Note that k is the maximum order of the tensor that causes the NMTF problem. Each vertex set of this k-partite graph is a set of factor matrices that can be updated at the same time. By scanning all the vertex sets, processing corresponding to one loop of the update procedure in the conventional technique is performed earlier. FIG. 2 illustrates an example of update when a k-partite graph is used.

Next, details of the k-partite graph will be described.

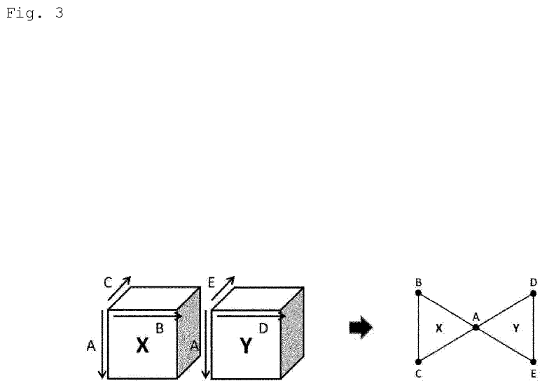

First, as illustrated in FIG. 3, when a factor matrix is considered as a vertex and the relationship that factor matrices form a same tensor is considered as an edge, it is possible to represent the NMTF problem by a graph.

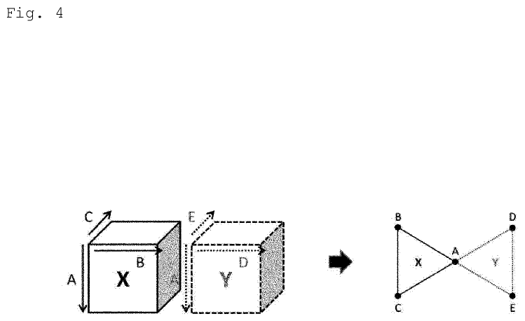

Next, as illustrated in FIG. 4, focusing on a subgraph corresponding to a k-th order tensor, the subgraph is a complete graph including k points. At the same time, this subgraph can also be called a k-partite graph in which the number of vertices in each vertex set is one. Note that a k-partite graph is considered as a graph in which the vertex set is divided into k subsets, and the vertices in each subset have no edges.

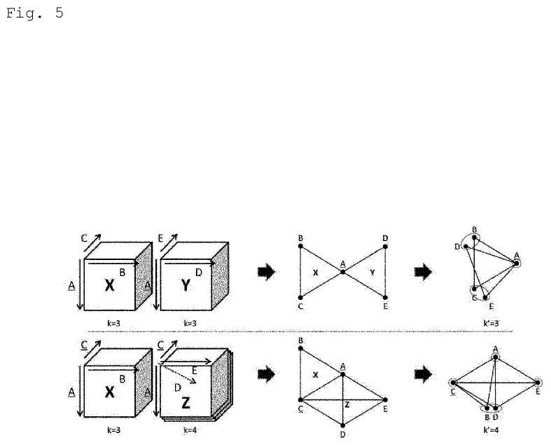

Next, as illustrated in FIG. 5, it is considered that each subgraph is connected by vertex sets corresponding to shared factor matrices. The entire graph connected by these vertex sets becomes a k′-partite graph for the larger number of vertices k′ in respective subgraphs.

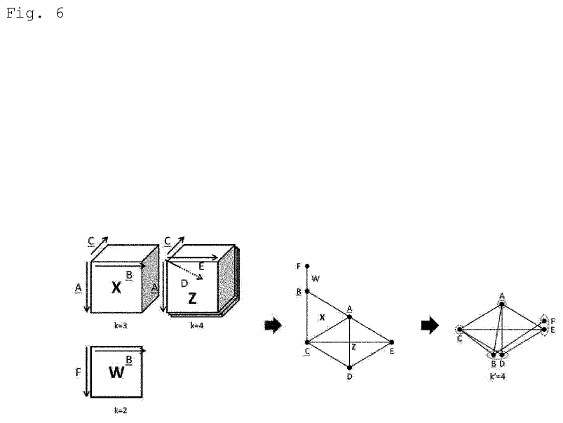

Next, as illustrated in FIG. 6, even if there is the NMTF problem in three or more tensors, the entire graph in which the above-described connection is repeated for all subgraphs will become a k′-partite graph for the highest order k′ of the orders of the tensors that forms the NMTF.

Using the above k-partite graph makes it possible to find a set of factor matrices that can be updated at the same time.

Hereinafter, based on the above premise, a specific configuration of a processing device will be described.

The processing device according to the embodiment of the present invention is a processing device that decomposes each of a plurality of tensors represented by a multi-dimensional array in which axes are set as modes corresponding to attributes into a plurality of factor matrices. The processing device according to the embodiment of the present invention performs the decomposition so that in the decomposition, at least one of the factor matrices obtained by decomposing the tensor is shared with a factor matrix obtained by decomposing another tensor.

<Configuration of Processing Device According to Embodiment of Present Invention>

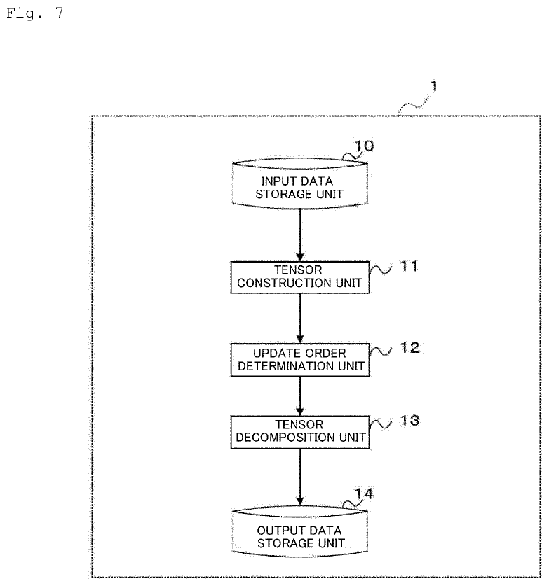

Next, a configuration of the processing device according to the embodiment of the present invention will be described. As illustrated in FIG. 7, the processing device 1 according to the embodiment of the present invention may include a computer that includes a CPU, a RAM, and a ROM storing a program and various data for executing a processing routine described later.

The processing device 1 functionally includes an input data storage unit 10, a tensor construction unit 11, an update order determination unit 12, a tensor decomposition unit 13, and an output data storage unit 14 as illustrated in FIG. 7.

The input data storage unit 10 stores a plurality of non-negative tensors to be subjected to factorization (hereinafter, simply referred to as tensors) and parameters used in the factorization. It is assumed that these are stored in advance.

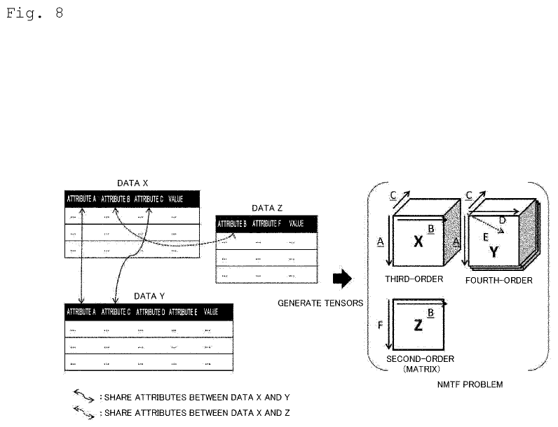

FIG. 8 illustrates an example of tensors stored in the input data storage unit 10. Three tensors X, Y, and Z are constructed based on data X, Y, and Z. The data X has a value determined by attribute information {A, B, C}, so that the tensor X has modes {A, B, C}, and has an element of a value corresponding to the modes (attribute information). The same applies to the tensors Y and Z.

When the NMTF problem is considered, each tensor shares at least one mode with another tensor. This means that each piece of data that is the base of the tensor shares at least one piece of attribute information with another piece of data.

The tensor construction unit 11 takes out a plurality of tensors from the input data storage unit 10 and loads them into the RAM, constructing tensors in the processing device 1.

The update order determination unit 12 constructs, based on each of the plurality of tensors, a graph in which a plurality of factor matrices obtained by decomposing the tensors are set as vertices, and the vertices of factor matrices obtained by decomposing a same tensor are connected by edges. Next, the update order determination unit 12 assigns a number to each vertex of the graph so that the same number is not assigned to the other vertex connected by an edge. Furthermore, the update order determination unit 12 determines an order of updating the factor matrices in a manner that factor matrices assigned a same number are set as a set of factor matrices to be subjected to parallel processing.

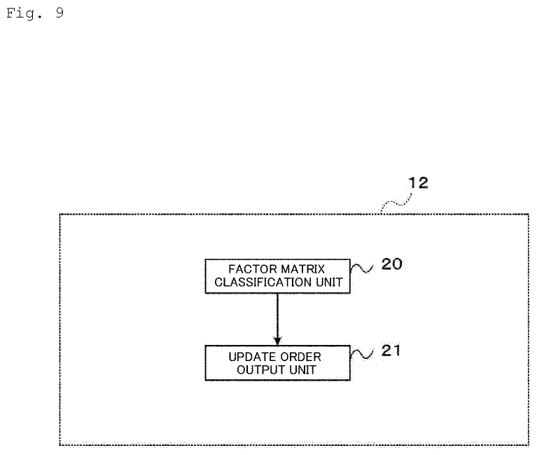

As illustrated in FIG. 9, the update order determining unit 12 includes a factor matrix classification unit 20 and an update order output unit 21. Detailed processing of each processing unit will be described in operations described later.

The factor matrix classification unit 20 classifies the factor matrices related to all the tensors read by the tensor construction unit 11. Detailed processing will be described later in the operations.

The update order output unit 21 outputs the order of updating the factor matrices based on a classification result of the factor matrix classification unit 20. Detailed processing will be described later in the operations.

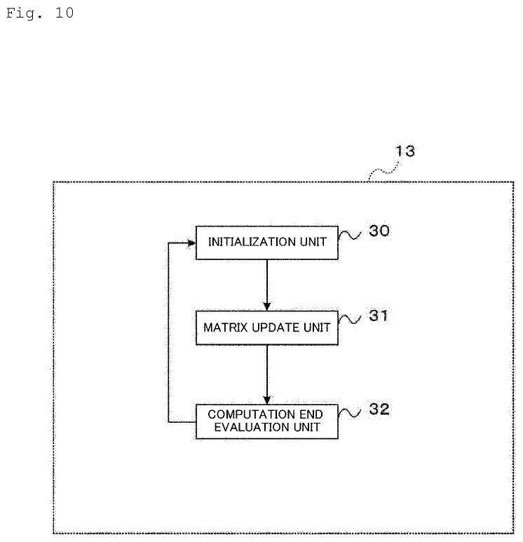

As illustrated in FIG. 10, the tensor decomposition unit 13 decomposes each of a plurality of tensors into a plurality of factor matrices. In the above decomposition, the tensor decomposition unit 13 updates the factor matrices in the order of updating based on the plural tensors. Further, in the above decomposition, the tensor decomposition unit 13 performs the decomposition by repeatedly updating a set of factor matrices to be subjected to parallel processing in parallel.

The tensor decomposition unit 13 includes an initialization unit 30, a matrix update unit 31, and a calculation end evaluation unit 32.

The initialization unit 30 performs initialization processing required for factorization of the tensors. Specifically, the initialization unit 30 reserves an area for storing the factor matrices corresponding to the respective modes of the tensors on the RAM, and substitutes random numbers as initial values for all elements of all factor matrices.

The matrix update unit 31 updates the factor matrices using a factor matrix update formula. Detailed processing will be described later in the operations.

The calculation end evaluation unit 32 determines, based on a predetermined end condition, whether to end updating the factor matrices in the matrix update unit 31 or to cause the matrix update unit 31 to update the matrices again. Specifically, the calculation end evaluation unit 32 calculates an estimated value for each tensor from the factor matrices corresponding to the tensor, and calculates a distance between the original tensor and the estimated tensor. Generalized KL divergence can be used for the tensor distance. The predetermined end condition is when the tensor distance satisfies a preset end condition or when the number of calculations reaches a preset upper limit. The calculation end evaluation unit 32 ends the updating when the end condition is satisfied, and returns the processing to the matrix update unit 31 when the upper limit is not reached.

The output data storage unit 14 stores the factor matrices obtained by the tensor decomposition unit 13.

<Operations of Processing Device According to Embodiment of Present Invention>

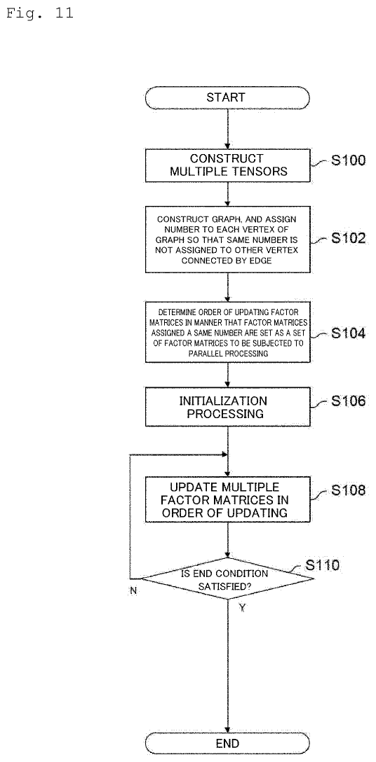

Next, operations of the processing device 1 according to the embodiment of the present invention will be described. The processing device 1 executes a processing routine illustrated in the flowchart of FIG. 11.

First, in step S100, the tensor construction unit 11 reads a plurality of tensors to construct the tensors.

Next, in step S102, the factor matrix classification unit 20 constructs, based on each of the tensors, a graph in which a plurality of factor matrices obtained by decomposing the tensors are set as vertices, and the vertices of factor matrices obtained by decomposing a same tensor are connected by edges. Next, also in step S102, the factor matrix classification unit 20 assigns a number to each vertex of the graph so that the same number is not assigned to the other vertex connected by an edge.

In step S104, the update order output unit 21 determines an order of updating the factor matrices in a manner that factor matrices assigned a same number are set as a set of factor matrices to be subjected to parallel processing.

In step S106, the initialization unit 30 performs initialization processing required for factorization of the tensors.

In step S108, the matrix update unit 31 updates the factor matrices in the order of updating based on the tensors. At this time, the matrix update unit 31 updates a set of factor matrices to be subjected to parallel processing in parallel.

In step S110, the calculation end evaluation unit 32 determines whether or not the predetermined end condition is satisfied. When the end condition is satisfied, the calculation end evaluation unit 32 ends the updating the factor matrices in the matrix update unit 31. On the other hand, when the end condition is not satisfied, the processing of the processing device 1 returns to step S108 to update the factor matrices again.

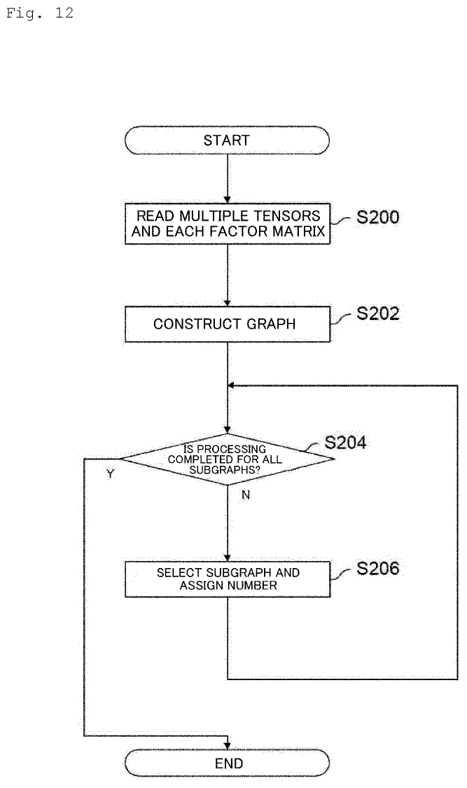

Next, details of the processing of the factor matrix classification unit 20 in step S102 will be described with reference to the flowchart of FIG. 12.

In step S200, the factor matrix classification unit 20 reads the tensors constructed by the tensor construction unit 11 and the factor matrices obtained by decomposing the tensors.

In step S202, the factor matrix classification unit 20 constructs a graph in which the factor matrices are set as vertices and the relationships in which two or more factor matrices are present in the same tensor are set as edges. The graph is constructed such that the subgraphs, which are composed of vertices of a plurality of factor matrices obtained by decomposing one tensor and edges between the vertices of the factor matrices, are combined.

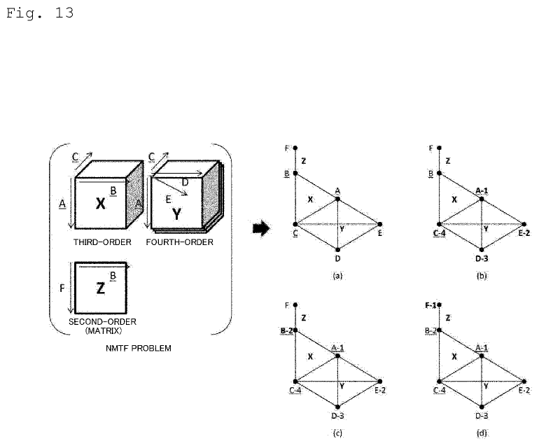

In FIG. 13, (a) illustrates an example in which three tensors and factor matrices related to the tensors are graphed.

In step S204, the factor matrix classification unit 20 determines whether or not the processing has been completed for all subgraphs corresponding to the respective tensors. The factor matrix classification unit 20 ends this processing routine if all the processing has been completed, and moves the processing to step S206 to repeat the corresponding processing if there is a subgraph for which the processing has not been completed.

In step S206, the factor matrix classification unit 20 selects a subgraph, and assigns, to a vertex with a number not having been assigned among the vertices of the selected subgraph, a number that is not the same as that of the other vertex connected by the edge in order starting from 1. The order in which the subgraphs are selected can be determined in such a way that, for example, if any subgraph has never been selected, then any subgraph is selected, otherwise a subgraph adjacent to any of the already selected subgraphs is selected. Ina case where a vertex has already been assigned a same number in a plurality of vertices belonging to the selected subgraph due to the selection of a plurality of adjacent subgraphs, the same numbers may be exchanged to resolve the issue in the adjacent subgraphs.

In FIG. 13, (b) to (d) illustrate examples in which numbers are assigned to the vertices of each subgraph. In (b), the vertices A, E, D, and C of the subgraph corresponding to the tensor Y are assigned numbers 1 to 4.

Then, in (c), when numbers are assigned to the vertices A, C, and B of the subgraph corresponding to the tensor X, A and C have already been assigned 1 and 4, so that B is assigned a number of 2, which is not the same, in order starting from 1. Finally, in (d), when numbers are assigned to the vertices B and F of the subgraph corresponding to the tensor Z, B has already been assigned 2, so that F is assigned a number of 1, which is not the same, in order starting from 1.

The above is the details of the processing of the factor matrix classification unit 20. As described above, numbers are assigned so that for each subgraph, the vertices of the subgraph are assigned different numbers, each being not the same number as the other vertex connected by the edge, in order starting from a predetermined number. Note that the predetermined number is not limited to a number starting from 1, and may be a number starting from 0.

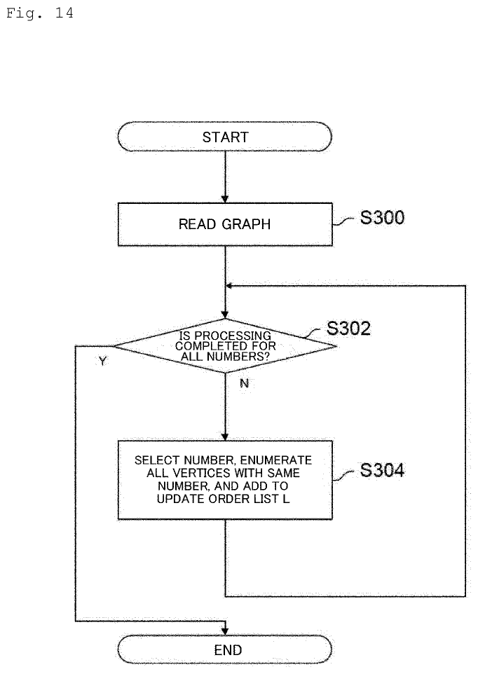

Next, details of the processing of the update order place output unit 21 in step S104 will be described with reference to the flowchart of FIG. 14.

In step S300, the update order output unit 21 reads a graph from the factor matrix classification unit 20.

In step S302, the update order output unit 21 determines whether or not the processing has been completed for all numbers assigned to the vertices of the graph. The update order output unit 21 ends this processing routine if all the processing has been completed for all numbers, and moves the processing to step S304 to repeat the corresponding processing if there is a number for which the processing has not been completed.

In step S304, the update order output unit 21 selects a number, enumerates all the vertices with the same number, and adds them to an update order list L.

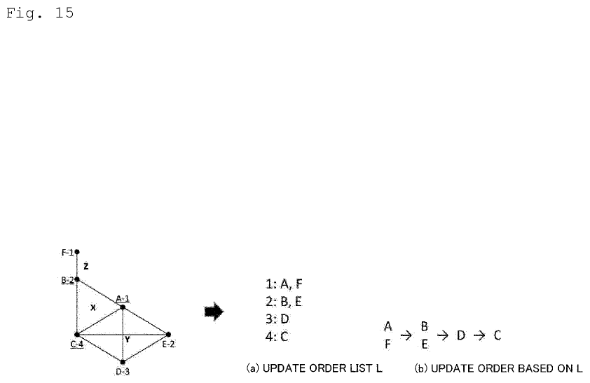

In FIG. 15, (a) illustrates an example in which vertices are enumerated for each number. It can be seen that sequentially reading this update order list L as illustrated in (b) of FIG. 15 makes it possible to update each of the combinations of factor matrices {A, F} and {B, E} by parallel processing at the same time.

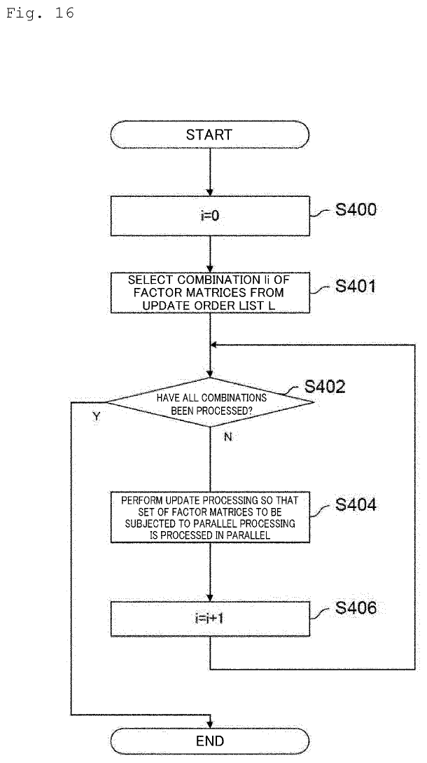

Next, details of the processing of the matrix update unit 31 in step S104 will be described with reference to the flowchart of FIG. 16.

In step S400, the matrix update unit 31 sets i as i=0.

In step S401, the matrix update unit 31 selects a combination lᵢ of factor matrices, which is an element in the update order list L, from the update order list L.

In step S402, the matrix update unit 31 determines whether all combinations in the update order list L have been processed. If all the combinations have been processed, the matrix update unit 31 ends this processing routine. If there is a combination that has not been processed, the matrix update unit 31 moves the processing to step S404 to repeat the corresponding processing. If i is greater than or equal to the size of L, this processing routine ends, and if less than the size of L, the processing proceeds to step S404.

In step S404, the matrix update unit 31 performs update processing on each factor matrix included in lᵢ so that a set of factor matrices to be subjected to parallel processing is processed in parallel. Taking the update order list L of (a) of FIG. 15 as an example, the matrix update unit 31 performs the update processing on the factor matrices A and F in parallel for l₁={A, F}. Similarly, the matrix update unit 31 processes the factor matrices B and E in parallel for l₂={B, E}. Since there is only one factor matrix for l₃={D} and l₄={C}, the matrix update unit 31 does not process the factor matrices D and C in parallel.

For example, when the tensor A⁽⁰⁾ is decomposed into factor matrices T, U, and V, each element t of the factor matrix T to be updated is updated based on an update formula of the following Formula (1).

$$\begin{matrix}[ Formula . 1 ] & \\ {t}_{ir}^{( new )} = {t}_{ir} \frac{{\sum }_{j = 1}^{{J}_{0}} {\sum }_{k = 1}^{{K}_{0}} [ \frac{{a}_{ijk}^{( 0 )}}{{\hat{a}}_{ijk}^{( 0 )}} {u}_{jr}^{( 0 )} {v}_{kr}^{( 0 )} ]}{{\sum }_{j = 1}^{{J}_{0}} {\sum }_{k = 1}^{{K}_{0}} {u}_{jr}^{( 0 )} {v}_{kr}^{( 0 )}} & ( 1 )\end{matrix}$$

Formula (1) is an update formula for updating an element tᵢᵣ of the factor matrix T for the generalized KL divergence being used as the distance between tensors. Here, tᵢᵣ represents an element in the i-th row and the r-th column in the factor matrix t, and a_{i,j,k}⁽ⁿ⁾ represents an element of the n-th tensor such that t is the factor matrix of that mode. And, \hat{ }a_{i,j,k}⁽ⁿ⁾ represents an estimated value of the element of the n-th tensor. And, u⁽ⁿ⁾ and v⁽ⁿ⁾ represent factor matrices other than t of the n-th tensor. Although the tensor is assumed to be one third-order tensor for simplification, the number of tensors may be 1 or more and the order of the tensor may be any number of 2 or more. The details of the update formula are described in NPL 1.

In step S406, the matrix update unit 31 sets i=i+1, and returns the processing to step S402.

As described above, according to the processing device according to the embodiment of the present invention, constructing a graph, assigning a number, determining an order of updating factor matrices, and decomposing factor matrices are each performed as follows, thereby making it possible to perform factorization at high speed while maintaining consistency. The above-mentioned constructing a graph is constructing, based on each of the tensors, a graph in which a plurality of factor matrices obtained by decomposing the tensors are set as vertices, and the vertices of factor matrices obtained by decomposing a same tensor are connected by edges. The above-mentioned assigning a number is assigning a number to each vertex of a graph so that the same number is not assigned to the other vertex connected by an edge. The above-mentioned determining an order of updating factor matrices is determining an order of updating factor matrices in a manner that factor matrices assigned a same number are set as a set of factor matrices to be subjected to parallel processing. The above-mentioned decomposing factor matrices is decomposing each of the tensors into the factor matrices in a manner that based on the tensors, the factor matrices are updated in the order of updating by repeatedly updating the set of factor matrices to be subjected to parallel processing in parallel.

Further, of the points of the technique according to the embodiment of the present invention, the first point is to use a technique of determining a combination of factor matrices that can be updated in parallel by constructing, from input tensors, a graph indicating a relationship between the tensors and the factor matrices, and searching the constructed graph by a predetermined algorithm. The second point is that the technique does not depend on the number of tensors, the order of each tensor, and a shared relationship of factor matrices.

The first point means that the combination of factor matrices can be determined by graphing the relationship between the tensors and the factor matrices based on a predetermined rule and then searching this graph based on a predetermined algorithm. Here, the above-mentioned graphing makes it possible to clarify the reference relationship between the factor matrices in a form that allows easy search. Further, the combination of factor matrices is a combination of factor matrices which are not referred to each other, that is, which can maintain consistency even when the updating is performed at the same time.

The second point means that the present invention is also applicable to a large-scale problem and NM2F (non-negative multiple matrix factorization) which is a special example of NMTF because the technique of the first point does not depend on the number of tensors, the order of each tensor, and a shared relationship of factor matrices. Further, with the configuration of the processing device 1 described above, the processing device 1 can also process a special example that handles only one tensor, for example, NTF (non-negative tensor factorization) and NMF (non-negative matrix factorization).

Note that the present invention is not limited to the above-described embodiment, and various modifications and applications are possible without departing from the scope and spirit of the present invention.

### REFERENCE SIGNS LIST

1 Processing device
10 Input data storage unit
11 Tensor construction unit
12 Update order determination unit
13 Tensor decomposition unit
14 Output data storage unit
20 Factor matrix classification unit
21 Update order output unit
30 Initialization unit
31 Matrix update unit
32 Computation end evaluation unit

1. A processing device that decomposes each of a plurality of tensors into a plurality of factor matrices so that when each of the tensors represented by a multi-dimensional array in which axes are set as modes corresponding to attributes is decomposed into a plurality of factor matrices, at least one of the factor matrices obtained by decomposing the tensor is shared with a factor matrix obtained by decomposing another tensor, the processing device comprising:
an update order determiner configured to determine an order of updating the factor matrices in a manner that based on each of the tensors, the factor matrices obtained by decomposing the plurality of tensors are set as vertices, a graph is constructed in which vertices of factor matrices obtained by decomposing a same tensor are connected by edges, each vertex of the graph is assigned a number so that the vertex is not assigned the same number as the other vertex connected by the edge, and factor matrices assigned a same number are set as a set of factor matrices to be subjected to parallel processing; and
a tensor decomposer configured to decompose each of the tensors into the factor matrices in a manner that based on the tensors, the factor matrices are updated in the order of updating by repeatedly updating the set of factor matrices to be subjected to parallel processing in parallel.

2. The processing device according to claim 1, wherein the update order determiner assigns the number so that for each of a plurality of subgraphs, in the graph, which is composed of vertices of a plurality of factor matrices obtained by decomposing a tensor and edges between the vertices of the factor matrices, the vertices of the subgraphs are assigned different numbers, each being not the same number as the other vertex connected by the edge, in order starting from a predetermined number.

3. A processing method for a processing device that decomposes each of a plurality of tensors into a plurality of factor matrices so that when each of the tensors represented by a multi-dimensional array in which axes are set as modes corresponding to attributes is decomposed into a plurality of factor matrices, at least one of the factor matrices obtained by decomposing the tensor is shared with a factor matrix obtained by decomposing another tensor, the processing method comprising:
a determining, by an update order determiner, an order of updating the factor matrices in a manner that based on each of the tensors, the factor matrices obtained by decomposing the plurality of tensors are set as vertices, a graph is constructed in which vertices of factor matrices obtained by decomposing a same tensor are connected by edges, each vertex of the graph is assigned a number so that the vertex is not assigned the same number as the other vertex connected by the edge, and factor matrices assigned a same number are set as a set of factor matrices to be subjected to parallel processing; and
decomposing, by a tensor decomposer, each of the tensors into the factor matrices in a manner that based on the tensors, the factor matrices are updated in the order of updating by repeatedly updating the set of factor matrices to be subjected to parallel processing in parallel.

4. The processing method according to claim 3, wherein the determining by the update order determiner includes assigning the number so that for each of subgraphs, in the graph, which is composed of vertices of a plurality of factor matrices obtained by decomposing a tensor and edges between the vertices of the factor matrices, the vertices of the subgraph are assigned different numbers, each being not the same number as the other vertex connected by the edge, in order starting from a predetermined number.

5. A computer-readable non-transitory recording medium storing a computer-executable program for a device that when executed by a processor causes the computer the computer-executable program to:
determine, by an update order determiner, an order of updating a plurality of factor matrices in a manner that based on each of a plurality of tensors, the plurality of factor matrices obtained by decomposing the plurality of tensors are set as vertices, a graph is constructed in which vertices of factor matrices obtained by decomposing a same tensor are connected by edges, each vertex of the graph is assigned a number so that the vertex is not assigned the same number as the other vertex connected by the edge, and factor matrices assigned a same number are set as a set of factor matrices to be subjected to parallel processing; and
decompose, by a tensor decomposer, each of the tensors into the factor matrices in a manner that based on the tensors, the factor matrices are updated in the order of updating by repeatedly updating the set of factor matrices to be subjected to parallel processing in parallel.

6. The computer-readable non-transitory recording medium of claim 5, wherein the determine by the update order determiner includes assigning the number so that for each of a plurality of subgraphs, in the graph, which is composed of vertices of a plurality of factor matrices obtained by decomposing a tensor and edges between the vertices of the factor matrices, the vertices of the subgraphs are assigned different numbers, each being not the same number as the other vertex connected by the edge, in order starting from a predetermined number.

7. The processing device according to claim 1, wherein each of the tensors shares at least one of the modes with another tensor of the tensors.

8. The processing device according to claim 1, wherein a tensor is associated with data, and the data includes one or more of the attributes represented by a mode.

9. The processing device according to claim 2, the device further comprising:
a calculation end evaluator configured to evaluate, based on a predetermined end condition, whether to end the updating of the factor matrices, wherein the predetermined end condition includes a predetermined distance between two of the plurality of tensors.

10. The processing device according to claim 2, the device further comprising:
an output data storage configured to store the factor matrices obtained by the tensor decomposer.

11. The processing device according to claim 2, the device further comprising:
concurrently processing a plurality of factor matrices in the set of factor matrices to be subjected to parallel processing.

12. The processing method according to claim 3, wherein each of the tensors shares at least one of the modes with another tensor of the tensors.

13. The processing method according to claim 3, wherein a tensor is associated with data, and the data includes one or more of the attributes represented by a mode.

14. The processing method according to claim 4, the method further comprising:
evaluating, by a calculation end evaluator based on a predetermined end condition, whether to end the updating of the factor matrices, wherein the predetermined end condition includes a predetermined distance between two of the plurality of tensors.

15. The processing method according to claim 4, the method further comprising:
storing, by an output storage, the factor matrices obtained by the tensor decomposer.

16. The processing method according to claim 4, the method further comprising:
concurrently processing a plurality of factor matrices in the set of factor matrices to be subjected to parallel processing.

17. The computer-readable non-transitory recording medium of claim 5, wherein each of the tensors shares at least one of the modes with another tensor of the tensors.

18. The computer-readable non-transitory recording medium of claim 5, wherein a tensor is associated with data, and the data includes one or more of the attributes represented by a mode.

19. The computer-readable non-transitory recording medium of claim 6, the processor further causes the computer the computer-executable program to:
evaluate by a calculation end evaluator based on a predetermined end condition, whether to end the updating of the factor matrices, wherein the predetermined end condition includes a predetermined distance between two of the plurality of tensors.

20. The computer-readable non-transitory recording medium of claim 6, the processor further causes the computer the computer-executable program to:
concurrently process a plurality of factor matrices in the set of factor matrices to be subjected to parallel processing.
